(19) United States
(12) Patent Application Publication
(10) Pub. No.: US 2009/0127510 A1
(43) Pub. Date: May 21, 2009

(54) Fine particle and red fluorescence conversion medium using the same

(75) Inventors: Tetsuhiko Isobe, Kanagawa (JP); Ryo Kasuya, Kanagawa (JP); Junichi Katano, Chiba (JP)

Correspondence Address: OBLON, SPIVAK, MCCLELLAND MAIER & NEUSTADT, P.C., 1940 DUKE STREET, ALEXANDRIA, VA, 22314, US

(73) Assignees: KEIO UNIVERSITY, Tokyo (JP); Idemitsu Kosan Co., Ltd., Tokyo (JP)

(21) Appl. No.: 11/920,831

(22) PCT Filed: May 10, 2006
(86) PCT No.: PCT/JP2006/309383

§ 371 Date: Nov. 21, 2007

(30) Foreign Application Priority Data
May 23, 2005 (JP) 2005-148991

(51) Int. Cl. C09K 11/02; B32B 5/16

(52) U.S. Cl. 252/301.36; 428/402

(57) ABSTRACT

Particles including at least a metal oxide represented by the following formula and having a number-average particle diameter of 100 nm or less;

AₓL_{y}M_{z}Oᵤ

wherein A is an alkali metal selected from Li, Na, K, Cs and Rb, or silver; L is a trivalent rare earth element selected from Sc, Y, La, Ce, Pr, Nd, Pm, Sm, Eu, Gd, Tb, Dy, Ho, Er, Tm, Yb and Lu; M is W, Mo, Cr, Mn, Ru, Os, Ir or Re; x is 0 to 2; y is 0.5 to 2; z is 0.5 to 4; and u is 5 to 10.

### TECHNICAL FIELD

The invention relates to novel particles and a red fluorescence conversion medium using the same.

### BACKGROUND

Fluorescent materials which absorb a specific electromagnetic wave and emit visible light with a lower energy are widely known. Of these, due to the high durability thereof, inorganic fluorescent materials are used for a wide variety of applications as a key material of an emitting device such as plasma displays, cathode ray tubes, fluorescent lamps, and white-light emitting diodes.

Inorganic fluorescent materials which have heretofore been used are required to be baked at a significantly high temperature close to 1,000° C. Baking at such a high temperature imposes a heavy burden on equipment. Moreover, a red-light-emitting inorganic fluorescent material has not yet been known.

The red-light-emitting inorganic fluorescent material described in Non-Patent Document 1 is required to be treated at a high temperature for crystallization. The treated inorganic fluorescent material is white powder which reflects visible rays, and not transparent.

Non-Patent Document 1: Journal of the Japan Society of Color Material, 74 [10], 495 (2001)

An object of the invention is to provide novel particles, and a red fluorescence conversion medium, an emitting device, and an information transmitting medium using the same.

The invention provides the following particles and red fluorescence conversion medium, and the like.

1. Particles comprising at least a metal oxide represented by the following formula and having a number-average particle diameter of 100 nm or less;

AₓL_{y}M_{z}Oᵤ

wherein A is an alkali metal selected from Li, Na, K, Cs and Rb, or silver;

L is a trivalent rare earth element selected from Sc, Y, La, Ce, Pr, Nd, Pm, Sm, Eu, Gd, Tb, Dy, Ho, Er, Tm, Yb and Lu;

M is W, Mo, Cr, Mn, Ru, Os, Ir or Re;

x is 0 to 2;

y is 0.5 to 2;

z is 0.5 to 4; and

u is 5 to 10.

2. The particles according to 1 which has an average transmittance of 50% or more of light having a wavelength of 400 to 700 nm.
3. The particles according to 1 or 2 wherein the metal oxide is synthesized at a temperature of 500° C. or less.
4. A method for producing the metal oxide contained in the particles according to any one of 1 to 3, comprising:

synthesizing the metal oxide from an A-containing salt, an L-containing salt, and an M-containing salt or oxide at a temperature of 500° C. or less.

5. A red fluorescence conversion medium comprising the particles of any one of 1 to 3.
6. An emitting device or an information transmitting medium comprising the red fluorescence conversion medium of 5.
7. A dispersion wherein the particles of any one of 1 to 3 are dispersed in a solvent or resin.
8. Fluorescence ink wherein the particles of any one of 1 to 3 are dispersed in a solvent or resin.
9. A method for producing the red fluorescence conversion medium of 5 using the fluorescence ink of 7.

The invention provides novel particles, and a red fluorescence conversion medium, an emitting device, and an information transmitting medium using the same.

### BRIEF DESCRIPTION OF DRAWINGS

FIG. 1 is a view showing a particle size distribution of a transparent dispersion obtained in Example 1 measured by the dynamic light scattering method;

FIG. 2 is a view showing fluorescence and excitation spectra of a transparent dispersion obtained in Example 1;

FIG. 3 is a view showing X-ray diffraction profiles of NaYW₂O₈ and sample powder obtained in Example 2; and

FIG. 4 is a view showing fluorescence and excitation spectra of a transparent dispersion gel obtained in Example 2.

### BEST MODE FOR CARRYING OUT THE INVENTION

The particles of the invention comprise at least a metal oxide represented by the following formula:

AₓL_{y}M_{z}Oᵤ

wherein A is an alkali metal selected from Li, Na, K, Cs and Rb, or silver, preferably Li and K. L is a trivalent rare earth element selected from Sc, Y, La, Ce, Pr, Nd, Pm, Sm, Eu, Gd, Tb, Dy, Ho, Er, Tm, Yb and Lu, preferably Eu and Tb. M is W, Mo, Cr, Mn, Ru, Os, Ir or Re, preferably W and Mo. x is 0 to 2, preferably 0.5 to 2. y is 0.5 to 2. z is 0.5 to 4, preferably 1 to 4. u is 5 to 10, preferably 6 to 10.

Preferable metal oxides include KEuMo₂O₈, KEuW₂O₈, LiEuMo₂O₈, and LiEuW₂O₈.

The number-average particle diameter of the metal oxide of the invention is 100 nm or less, preferably 80 nm or less. The number-average particle diameter can be adjusted by centrifugation, filtering, or the like.

It is preferred that the particles of the invention be transparent. Specifically, the particles of the invention have an average transmittance of light having a wavelength of 400 to 700 nm of 50% or more. Transmittance is measured by dispersing the particles in a solvent such as 1,4-butylene glycol or a resin, and allowing light having a wavelength of 400 to 700 nm to be transmitted through the dispersion. The dispersion preferably transmits an average of 50% or more of the light, more preferably 75% or more, with an optical path length of 10 mm.

The transparent particles can emit fluorescence efficiently with minimized occurrence of scattering. Due to the transparency thereof, the transparent particles rarely color a product. It is possible to allow a necessary portion of the transparent particles to emit fluorescence when necessary.

Metal oxide constituting the particles of the invention can be synthesized from an A-containing salt, an L-containing salt, an M-containing salt or oxide at a temperature of 100° C. to 500° C. When x is 0, it is not necessary to use the A-containing salt. LiEuW₂O₈, for example, can be synthesized from an acid lithium salt such as lithium acetate, an acid europium salt such as europium (III) acetate, and an acid tungsten salt such as tungsten phosphate or a tungsten-containing oxide in a solvent such as ethylene glycol, 1,4-butylene glycol and 1,3-butylene glycol at a temperature of 200° C. or less. It is preferred that the solvent be preheated to 150 to 200° C. The reaction time is normally 30 to 180 minutes, but not limited thereto. The reaction time can be selected appropriately. The reaction pressure is normally 1.0 to 5.0 Mpa, but not limited thereto. The reaction pressure can be selected appropriately.

The particles of the invention may be formed of a metal oxide only or a metal oxide to which an organic residue (alkyl, alkyloxy, alkylcarbonyl, alkylcarbonyloxy) is bonded. As the metal oxide to which an organic residue is bonded, (CH₃COO)₂LiEuW₂O₇ can be given, for example. By dissolving an organic residue-containing carboxylic acid (salt), an organic residue-containing carboxylic anhydride (salt), an organic residue-containing alcohol, an organic residue-containing ester or the like in a solvent quantitavely or excessively (possible to use as a solvent), they are allowed to react with a metal oxide during particle formation and bonded thereto, whereby the metal oxide to which the organic residue is bonded is formed. Due to the bonding of the organic residue, dispersibility in various solvents or transparency is improved.

Since the above metal oxide can emit red light, the particles of the invention can be used as a red fluorescence conversion medium.

Generally, red light means light having a wavelength of 580 to 700 nm. For example, LiEuW₂O₈ absorbs light having a wavelength of 200 to 425 nm and emits red light.

The red fluoresence conversion medium is normally a dispersion in which the particles of the invention are dispersed in a medium such as a solvent and resin.

The metal oxide contained in the particles may be surface-modified with a metal oxide such as silica or an organic substance in order to prevent destruction of the crystal structure and disappearance of fluorescent properties.

Further, the metal oxide surface may be modified or coated with a long-chain alkyl group, phosphoric acid, a resin, or the like in order to improve dispersibility in the medium.

The medium is a medium for dispersing and holding the particles. It is preferred that the medium be transparent. Transparent materials such as glass and a transparent resin can be selected.

Specific examples include transparent resins (polymer) such as polymethyl methacrylate, polyacrylate, polycarbonate, polyvinyl alcohol, polyvinylpyrrolidone, hydroxyethyl cellulose, and carboxymethyl cellulose.

A photosensitive resin for photolithography may also be selected.

Examples include photo-setting resist materials having reactive vinyl groups of various types such as acrylic acid type, methacrylic acid type, polyvinyl cinnamate type and cyclic rubber type.

In the case where a printing method is used, printing ink (medium) using a transparent resin may be selected. Monomers, oligomers, and polymers of polyvinyl chloride resins, melamine resins, phenol resins, alkyd resins, epoxy resins, polyurethane resins, polyester resins, maleic acid resins and polyamide resins can be exemplified.

They may be thermosetting resins. These resins may be used singly or in mixtures.

The red fluorescence conversion medium can be prepared using a dispersion obtained by mixing and dispersing the particles and the medium by a known method such as milling and ultrasonic dispersion.

In this case, a good solvent of the above-mentioned transparent medium may be used. Using this dispersion, a pattern of the red fluorescence conversion medium can be prepared by photolithography or by various printing methods.

The red fluorescence conversion medium is preferably produced by a wet method such as spin coating and inkjet using fluorescence ink obtained by dispersing the particles in a solvent or a resin since a uniform film can be formed.

The mixing ratio of the particles and the transparent medium (particles/transparent medium:weight ratio) is preferably 1/20 to 4/6, more preferably 1/9 to 3/7, although it varies according to the specific gravity and size of the particles.

A UV absorber, a dispersant, a leveling agent or the like may be added to the red fluorescence conversion medium insofar as the object of the invention can be attained.

An emitting device or an information transmitting medium containing the red fluorescence conversion medium of the invention can be fabricated. As examples of the information transmitting medium, illuminators, console panels, and televisions can be given.

### EXAMPLES

### Example 1

2.5 mmol (0.255 g) of lithium acetate, 2.5 mmol (1.003 g) of europium (III) acetate, and 0.4167 mmol (1.200 g) of phosphotungstic acid were incorporated into 50 ml of 1,4-butlylene glycol preheated to 180° C. With stirring at room temperature, the mixture was aged for 80 minutes to obtain a transparent dispersion. The resulting transparent dispersion emitted red light when excited with light having a wavelength of 465 nm.

As mentioned above, the intended particles (metal oxide) could be produced readily at a low temperature.

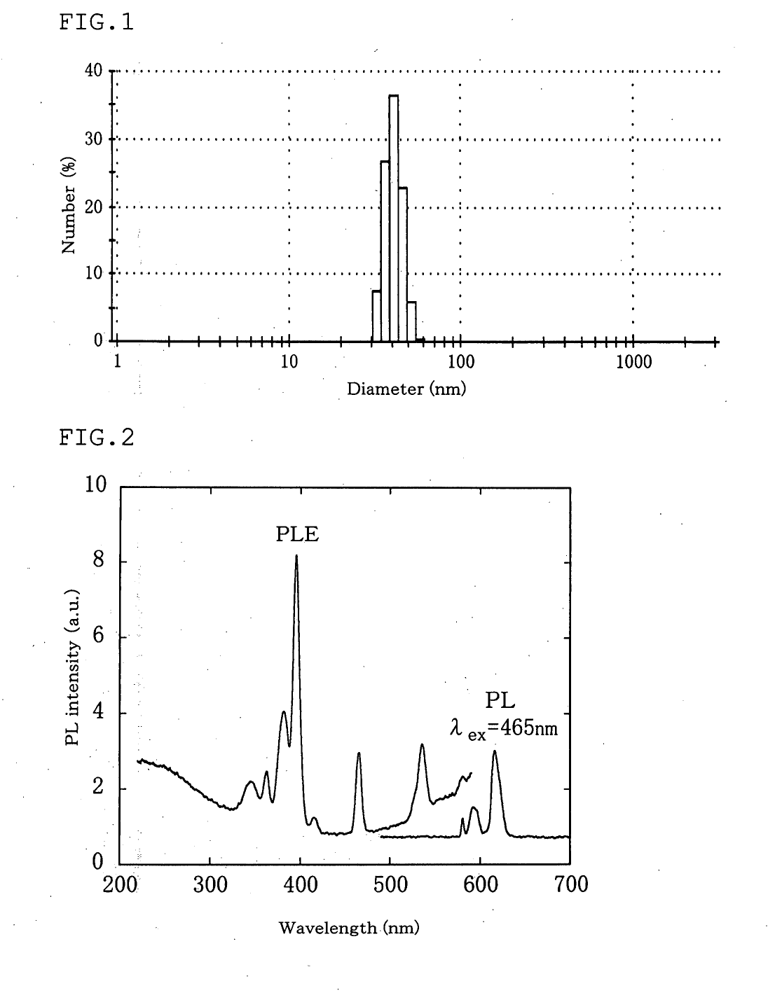

As for a solution obtained by diluting the transparent dispersion with water, the particle size distribution was measured by the dynamic light scattering method. The results obtained are shown in FIG. 1. From FIG. 1, it is understood that nanoparticles with a particle diameter of about 40 nm were dispersed.

FIG. 2 shows fluorescence and excitation spectra of the transparent dispersion. In FIG. 2, an excitation peak and a red fluorescence peak derived from the f-f transition of Eu³⁺ were observed. In this figure, PLE indicates the excitation spectrum and PL indicates the emission spectrum.

The transparent dispersion was further dispersed in 1,4-butylene glycol. When light having a wavelength of 400 to 700 nm was transmitted, the average transmittance was 65%, with an optical path length of 10 mm.

### Example 2

2.5 mmol (0.255 g) of lithium acetate, 2.5 mmol (1.003 g) of europium (III) acetate, and 0.4167 mmol (1.200 g) of phosphotungstic acid were incorporated into 10 ml of 1,4-butylene glycol preheated to 180° C. With stirring at room temperature using a stirrer, the mixture was aged for 80 minutes to obtain a semitransparent gel. In this example, the dispersion having a concentration five times higher than that in Example 1 was prepared.

As a result of the measurement by the X-ray diffraction, it was found that the resulting semi-transparent gel was amorphous.

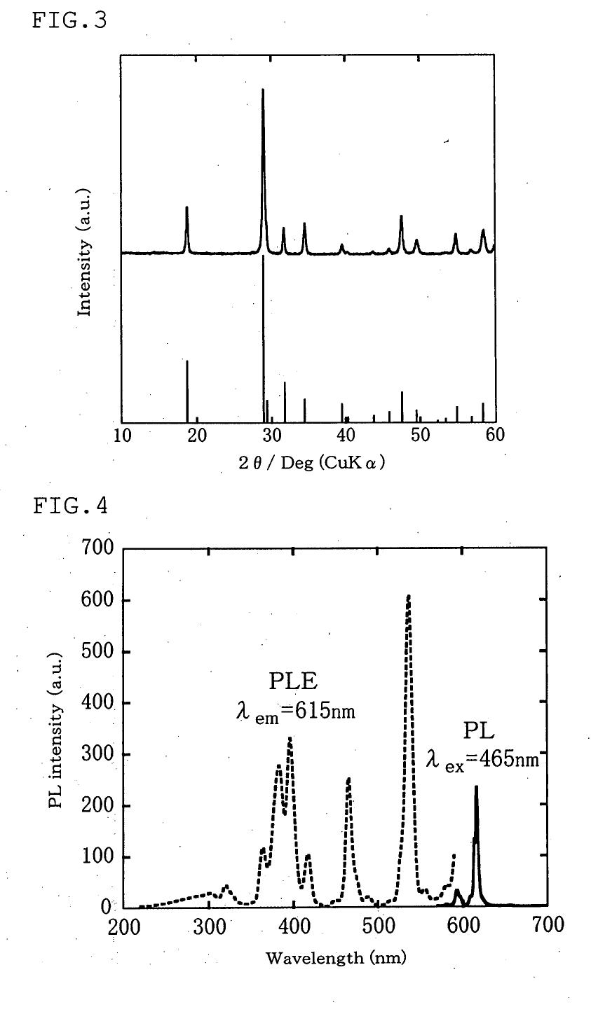

The semitransparent gel was heated at a heating speed of 10° C./min, followed by one-hour baking at 600° C. to obtain a powder sample. The X-ray diffraction profiles of the powder sample and NaYW₂O₈ are shown in FIG. 3. The upper profile indicates the profile of the powder sample, and the lower profile indicates the profile of NaYW₂O₈. The comparison of the profile of the powder sample with the profile of NaYW₂O₈ having the celite structure revealed that LiEuW₂O₈ with the celite crystal structure was generated.

FIG. 4 shows fluorescence and excitation spectra of the transparent dispersion gel. As shown in FIG. 4, an excitation peak and a red fluorescence peak derived from the f-f transition of Eu³⁺ were observed in the fluorescence and excitation spectra.

### Example 3

A sample was obtained in the same manner as in Example 2, except that the 1,4-butylene glycol was preheated to 600° C. in a sealed pressure-resistant vessel. The resulting sample was white with no transparency.

### INDUSTRIAL APPLICABILITY

The red fluorescence color conversion medium of the invention can be suitably used in commercial and industrial displays (advertisements, for example) and information transmitting mediums. Specific examples include sign boards, mobile phones, PDAs, car navigators, monitors, TVs, and illuminators.

1. Particles comprising at least a metal oxide represented by the following formula and having a number-average particle diameter of 100 nm or less;
AₓL_{y}M_{z}Oᵤ
wherein A is an alkali metal selected from Li, Na, K, Cs and Rb, or silver;
L is a trivalent rare earth element selected from Sc, Y, La, Ce, Pr, Nd, Pm, Sm, Eu, Gd, Tb, Dy, Ho, Er, Tm, Yb and Lu;
M is W, Mo, Cr, Mn, Ru, Os, Ir or Re;
x is 0 to 2;
y is 0.5 to 2;
z is 0.5 to 4; and
u is 5 to 10.

2. The particles according to claim 1 which has an average transmittance of 50% or more of light having a wavelength of 400 to 700 nm.

3. The particles according to claim 1 wherein the metal oxide is synthesized at a temperature of 500° C. or less.

4. A method for producing the metal oxide contained in the particles according to claim 1, comprising:
synthesizing the metal oxide from an A-containing salt, an L-containing salt, and an M-containing salt or oxide at a temperature of 500° C. or less.

5. A red fluorescence conversion medium comprising the particles of claim 1.

6. An emitting device or an information transmitting medium comprising the red fluorescence conversion medium of claim 5.

7. A dispersion wherein the particles of claim 1 are dispersed in a solvent or resin.

8. (canceled)

9. (canceled)

10. The particles according to claim 1 wherein an organic residue is bonded to the metal oxide.
